(19) United States
(12) Patent Application Publication
(10) Pub. No.: US 2010/0211539 A1
(43) Pub. Date: Aug. 19, 2010

(54) SYSTEM AND METHOD FOR BUILDING A DATA WAREHOUSE

(76) Inventor: Luy HO, Milton (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 12/479,508

(22) Filed: Jun. 5, 2009

Related U.S. Application Data
(60) Provisional application No. 61/059,065, filed on Jun. 5, 2008.

(51) Int. Cl. G06F 17/30

(52) U.S. Cl. 707/602; 707/E17.005

(57) ABSTRACT

There is disclosed a system and method of building a data warehouse. In an embodiment, the method comprises: receiving extract input parameters for extracting data from a source data file; building a communications channel to a selected one of a plurality of source database management systems containing the source data file in dependence upon the received extract input parameters; extracting data from the selected source data file and storing the extracted data into a staging table; receiving transform and load input parameters for transforming data stored in the staging table and loading the transformed data into a data warehouse table; and selecting pre-built modules for building the data warehouse with the data warehouse tables loaded with the transformed data in dependence upon the selected source database management system and the received extract, transform and load input parameters. In an embodiment, building the communications channel comprises dynamically creating an object linking and embedding (OLE) database server connection to the source database management system.

### RELATED APPLICATION INFORMATION

This application claims the benefit of U.S. Provisional Patent Application No. 61/059,065 filed Jun. 5, 2008, the disclosure of which is incorporated herein by reference in its entirety.

### FIELD OF THE INVENTION

The present disclosure relates generally to data warehouses and more particularly to a system and method for building data warehouses.

### BACKGROUND

Currently, common data warehouse development practice is to begin development with a business analyst or data analyst to gather the requirements for a data warehouse, and then to pass those requirements to a development team that then develops and codes the data warehouse design for the target environment. Once the data warehouse design is completed, programmers will develop the Extract, Transform, and Load processes based on the requirements they were given. Finally, the data warehouse must go through testing, scheduling, and maintenance cycles in order to ensure proper operation. Significant time, resources, cost, and risk are involved in such data warehouse projects and companies, particularly small to medium enterprises, may not be able to afford this custom design approach to developing and building data warehouses.

### SUMMARY

The present invention relates to a system and method for developing data warehouses. In an embodiment, the invention harnesses the capability of development platforms which allow a caller program to talk to many data sources, and further extends those capabilities by providing a database development environment in which the necessary data warehouse components may be built.

The system and method thus facilitates setup, configuration, generation, loading and management of data warehouse environments in a significantly reduced amount of time, without the need for pre-developed program templates or any significant custom programming.

In an aspect, there is provided a method of building a data warehouse, comprising: receiving extract input parameters for extracting data from a source data file; in dependence upon the received extract input parameters, building a communications channel to a selected one of a plurality of source database management systems containing the source data file; extracting data from the selected source data file and storing the extracted data into a staging table; receiving transform and load input parameters for transforming data stored in the staging table and loading the transformed data into a data warehouse table; and in dependence upon the selected source database management system and the received extract, transform and load input parameters, selecting pre-built modules for building the data warehouse with the data warehouse tables loaded with the transformed data.

In an embodiment, the method further comprises: receiving advanced load input parameters; and in dependence upon the selected source database management system and the received advanced load input parameters, selecting pre-built modules for performing the advanced loading of transformed data into a data warehouse table.

In another embodiment, building the communications channel comprises dynamically creating an object linking and embedding (OLE) database server connection to the source database management system.

In an embodiment, the method further comprises: in dependence upon data validation input parameters and upon completion of loading all tables, executing a data quality validation process on data stored in the tables; identifying any data records failing the data quality validation process; and verifying data integrity of the identified data records as they await correction of the source system files.

In an embodiment, the method further comprises executing the data quality validation process based on comparing the data to organization business rules.

In an embodiment, the pre-build modules are specific to each one of the plurality of source database management systems, and selection of the appropriate pre-build modules is made automatically based on user selection of the source database management system.

In an embodiment, the method further comprises modifying user interfaces for receiving transform and load input parameters in dependence upon the received extract input parameters and the selected source database management system.

In another aspect, there is provided a system for building a data warehouse, the system including processing means and memory means adapted to: receive extract input parameters for extracting data from a source data file; build a communications channel to a selected one of a plurality of source database management systems containing the source data file in dependence upon the received extract input parameters; extract data from the selected source data file and storing the extracted data into a staging table; receive transform and load input parameters for transforming data stored in the staging table and loading the transformed data into a data warehouse table; and select pre-built modules for building the data warehouse with the data warehouse tables loaded with the transformed data in dependence upon the selected source database management system and the received extract, transform and load input parameters.

In an embodiment, the system is further adapted to: receive advanced load input parameters; and select pre-built modules for performing the advanced loading of transformed data into a data warehouse table in dependence upon the selected source database management system and the received advanced load input parameters.

In another embodiment, the system is further adapted to build the communications channel comprises dynamically creating an object linking and embedding (OLE) database server connection to the source database management system.

In another embodiment, the system is further adapted to: execute a data quality validation process on data stored in the tables in dependence upon data validation input parameters and upon completion of loading all tables; identify any data records failing the data quality validation process; and verify data integrity of the identified data records as they await correction of the source system files.

In another embodiment, the system is further adapted to execute the data quality validation process based on comparing the data to organization business rules.

In another embodiment, the pre-build modules are specific to each one of the plurality of source database management systems, and selection of the appropriate pre-build modules is made automatically based on user selection of the source database management system.

In another embodiment, the system is further adapted to modify user interfaces for receiving transform and load input parameters in dependence upon the received extract input parameters and the selected source database management system.

In another aspect, there is provided a data processor readable medium for storing data processor code that when loaded into a data processing device adapts the device to perform a method of building a data warehouse, the data processor readable medium comprising: code for receiving extract input parameters for extracting data from a source data file; code for building a communications channel to a selected one of a plurality of source database management systems containing the source data file in dependence upon the received extract input parameters; code for extracting data from the selected source data file and storing the extracted data into a staging table; code for receiving transform and load input parameters for transforming data stored in the staging table and loading the transformed data into a data warehouse table; and code for selecting pre-built modules for building the data warehouse with the data warehouse tables loaded with the transformed data in dependence upon the selected source database management system and the received extract, transform and load input parameters.

In an embodiment, the data processor readable medium further comprises: code for receiving advanced load input parameters; and code for selecting pre-built modules for performing the advanced loading of transformed data into a data warehouse table in dependence upon the selected source database management system and the received advanced load input parameters.

In another embodiment, the data processor readable medium further comprises code for building the communications channel by dynamically creating an object linking and embedding (OLE) database server connection to the source database management system.

In another embodiment, the data processor readable medium further comprises: code for executing a data quality validation process on data stored in the tables in dependence upon data validation input parameters and upon completion of loading all tables; code for identifying any data records failing the data quality validation process; and code for verifying data integrity of the identified data records as they await correction of the source system files.

In another embodiment, the data processor readable medium further comprises: the data processor readable medium further comprises code for executing the data quality validation process based on comparing the data to organization business rules.

In another embodiment, the pre-build modules are specific to each one of the plurality of source database management systems, and the data processor readable medium further comprises code for selecting the appropriate pre-build modules automatically based on user selection of the source database management system.

In an embodiment, the data processor readable medium further comprises code for modifying user interfaces for receiving transform and load input parameters in dependence upon the received extract input parameters and the selected source database management system.

### BRIEF DESCRIPTION OF THE DRAWINGS

In the figures which illustrate exemplary embodiments:

FIG. 1 is a schematic block diagram of a data processing system that may provide an operating environment;

FIG. 2 is a schematic block diagram of a data warehouse development system in accordance with an embodiment; and

FIGS. 3 to 5 show schematic flowcharts of a method for building a data warehouse in accordance with an embodiment.

### DETAILED DESCRIPTION

As noted above, the present disclosure relates to a system and method for building data warehouses.

More generally, a system and method in accordance with an embodiment defines, selects and builds the necessary data warehouse components for the Extract, Transform and Load (“ETL”) activities associated with the creation and operation of a full function data warehouse.

The requirements of the data warehouse are defined by information parameter inputs entered at a user interface. The system and method enables the identification of data files to be included in the data warehouse, and for each of these data files, the system and method enables the specification of the network location of that file (e.g. the file name, server name, or library where it is physically located). For each of these data files, the system also enables the specification of the method (e.g. refresh, incremental, or interval) to be used to extract data from the data file.

The system and method then performs the Extract process to extract data from the source data files for storage into staging files. The system and method checks that the data extracted from the source data files complies with predetermined rules, and identifies and reports non-compliant data for correction.

For each of the data files, the system and method enables the specification of a plurality of fields that may be hash totalled during the ETL processes, as explained in more detail further below. The system and method also enables the specification of the specific database connection driver to be used as the main communication vehicle with that data file. The system then creates a staging table consisting of identical copies of the data files.

In an embodiment, the system and method allows the specification of one or more filters to select a specific subset of records to be included in the data warehouse. The system and method also allows the specification of tables as being regular (dimensional) or transactional (fact). Dimensional tables contain attributes that describe fact records in the fact tables. Some of these attributes provide descriptive information; other attributes are used to specify how fact table data should be summarized to provide useful information to the analyst. The fact table stores various measures (e.g. quantitative or factual data) of the business and points to a key value at the lowest level of each dimension table. The measures are generally quantitative and correspond to “how much” or “how many” types of questions. Primary keys may be specified for each warehouse table, and all or only certain fields may be selected for Load into the data warehouse.

In an embodiment, the system and method loads data using an “insert/update” procedure to ensure that the data warehouse tables preserve records no longer maintained in the source files. Since every single warehouse table is designed to maintain the history of data over the life time of the warehouse, the system and method brings changed data into the warehouse and performs two different operations. First, the system and method will check to see if there are any existing records in the warehouse table that match with new net change data. If there are, then the system and method will UPDATE those matched keys. Second, the system and method will insert the records that are not matched (or new) as INSERT. This approach allows Warehouse tables to maintain history while ensuring that the warehouse fully reflects the content of the source system.

At the completion of the extraction process, the system and method provides access to an Advanced Load function if there is a need to introduce more complex processes when loading staging data into the data warehouse. With this Advanced Load feature, the system enables the execution of stored procedures, SQL scripts and/or SQL Server Integration Services (“SSIS”) packages during the Load. The logic generated by the system and method can create and maintain more than one fact table. Also, the same logic generated to execute the initial data load of the warehouse from the staging table can be used to maintain the data warehouse over its life time. The system and method as summarized above will now be described in more detail.

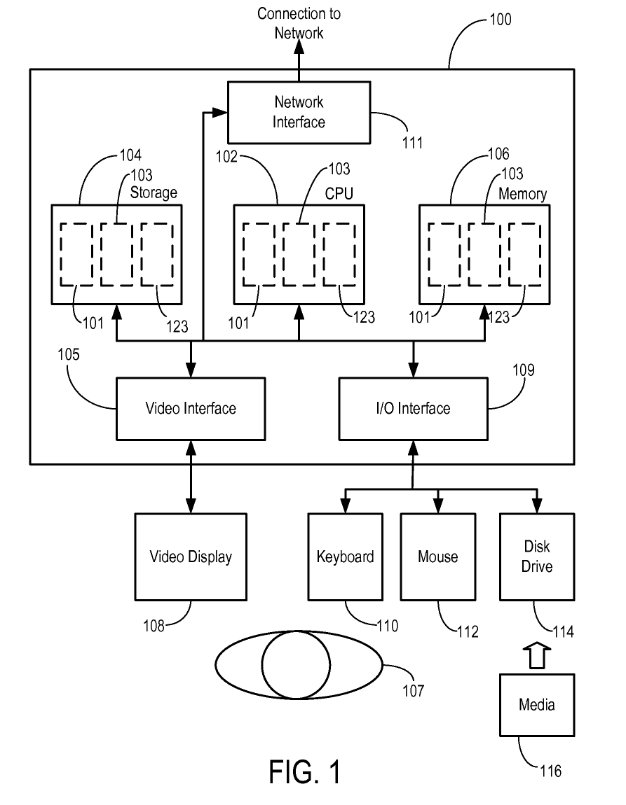

The invention may be practiced in various embodiments. A suitably configured data processing system, and associated communications networks, devices, software and firmware may provide a platform for enabling one or more embodiments. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (GUI) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown). The particular configurations shown by way of example in this specification are not meant to be limiting.

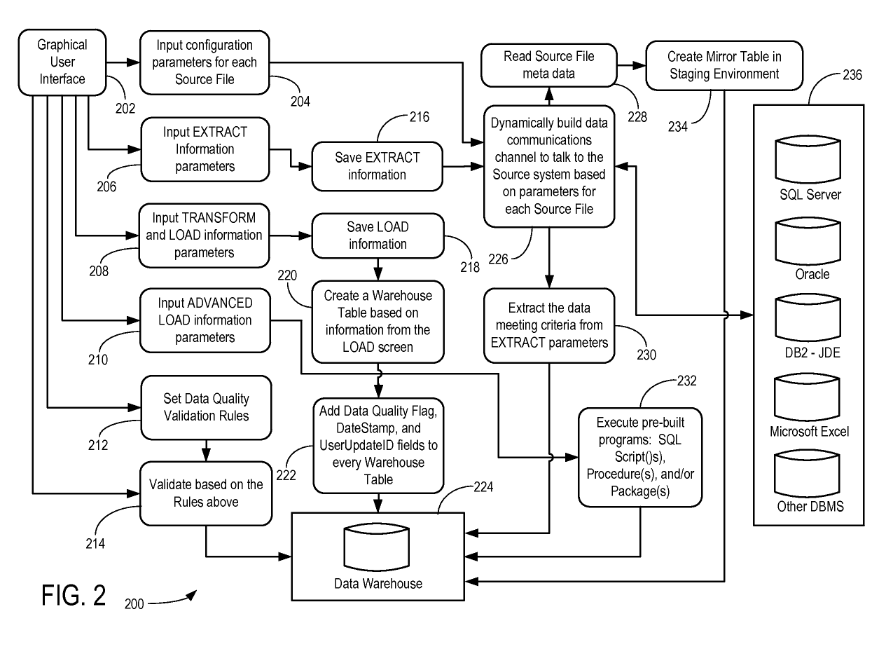

Now referring to FIG. 2, shown as a schematic block diagram of a system 200 for building a data warehouse in accordance with an embodiment. As shown, system 200 includes a graphical user interface (GUI) module 202 which may use to display various screens on a video display 108 (FIG. 1) for receipt of input. In an embodiment, GUI module 202 may be adapted to display various input screens for various input modules: input module 204 may be adapted to receive the input configuration parameters for each source file; input module 206 may be adapted to receive extract information parameters; input module 208 may be adapted to receive transformation and load information parameters; and input module 210 may be adapted to receive advanced load information parameters. GUI module 202 may also be used for module 212 which may be adapted to set data quality validation rules, and for module 214 which may be adapted for validating data quality based on various rules.

In an embodiment, the system 200 checks for data compliance with the organization's business rules, and reports non-compliant data. Upon receipt of corrections bringing non-compliant data into compliance, the system 200 identifies the data as being compliant. The quality of the data maintained in the data warehouse may be checked upon completion of the loading of all individual tables.

In an embodiment, the data quality checking process may also be performed following initial loading, following every scheduled data loading and following every “on-demand” loading of new data to the warehouse. The data quality checking process is thus the basis for identifying all errors that may affect the soundness of the data. A record of all errors found is maintained, and these records are then available for reporting for correction.

For each of the files and tables, the system 200 allows the selection of one or more columns that are to be checked for data quality. For each column selected, the system 200 allows the selection of a table and an associated column against which the selected column is to be edited. For each table associated with the selected column, system 200 allows the selection of a column containing the associated descriptive text or name.

In an embodiment, the process associated with data quality checking is based upon a predefined ordering of processing. The columns selected that are included in the reference tables (regular tables) are processed before the columns associated with fact tables (transaction tables) are processed, and rows with selected columns containing erroneous values are identified. The description of the error is maintained for subsequent reporting.

Processing the fact tables (transaction tables) follows completion of reference tables (regular tables) processing. Only rows identified as not having previously passed data quality checking are edited. Rows are then checked to determine if they contain columns with erroneous values. Rows identified as containing erroneous column values are noted, and the description of the error is maintained for subsequent reporting.

As shown in FIG. 2, once extract information parameters have been entered at input module 206, the extract information may be saved at module 216. Similarly, Transform and Load information parameters input at input module 208 may be saved at module 218. The Load information saved at module 218 may then be used to create or update a data warehouse table based on the Load information input module 208.

Upon creation of the warehouse table at module 220, various data may be added to various fields in the warehouse table at module 222. In addition, a data quality flag may be provided as an extra field for use in data quality validation. These flags will remain through the life of the data warehouse. As an example, every time a user invokes the validation process, the system and method will set a Flag to “N”, if any record fails the data integrity check. This flag will be maintained until a user corrects the data from the source system.

When the system and method creates warehouse tables, two extra fields called DateTimeStamp and UserIDUpdated will automatically be created. These two fields will identify when the records were updated or inserted, and who invoked the program to perform the last ETL processes. These two columns may be used for auditing, and for complying with regulatory requirements.

The warehouse table may then be provided as an input to the data warehouse 224. As shown, validation of data quality at module 214 may also be provided as an input to data warehouse 224.

Still referring to FIG. 2, output from module 204 is provided as an input to module 226 where the system 200 is adapted to dynamically build data communications channels to talk to the source system based on parameters for each source file. Module 226 may be adapted to dynamically build data communications channels to allow the system 200 to talk to any one of a number of different database management systems as shown at block 236, including SQL, Oracle™, IBM DB2 IDE™, Microsoft Excel™, and others.

The output from module 226 is provided as an input to module 228 where the system 200 reads the source file metadata. Output from module 226 is also provided as an input to module 230 where the system 200 extracts the data meeting criteria from the extract information parameters. The output from module 230 is provided as another input to data warehouse 224. System 200 will dynamically generate a data communication channel to the data source(s) identified as being required to populate the data warehouse 224, read the source file structure(s) and create identical table structure(s) on the system where the warehouse is intended to reside. The system 200 will then dynamically generate the ETL logic based on user input parameters specified by the user at input modules 204 to 210.

Referring back to block 210, the output from block 210 is provided as an input to module 232 where the system 200 executes pre-built program modules such as SQL scripts, procedure(s) and/or package(s). With Advanced Function, the system and method provides an environment where users (i.e. technical people) can implement some custom logic that only applies to their own business requirements. For example, a user may want to summarize the fact table data into monthly or quarterly values after loading a fact table into the warehouse. As another example, the user might want to merge the fact table with an external file from other system. The system and method also provides users with a wide range of programming implementations to introduce custom logic using whatever method of programming they feel most comfortable—such as SQL Script, and/or Stored-procedures, and/or SSIS Integration Packages. As shown, the output from module 232 is also provided as an input to data warehouse 224.

The output from module 228 is provided as an input to block 234, where the system creates a mirror table in a staging environment. The output from block 234 is provided as another input to the data warehouse 224.

In an illustrative embodiment, the system 200 may be developed around a database management system such as Microsoft™ SQL Server 2005, and around software components for addressing various common programming requirements such as Microsoft .NET Framework™ 2.0 technology. In an embodiment, the system uses dynamic SQL programming and Integration Packages (e.g. SQL Server Integration Service—SSIS) to convert, in real-time, the user provided parameters into executable code for building a data warehouse.

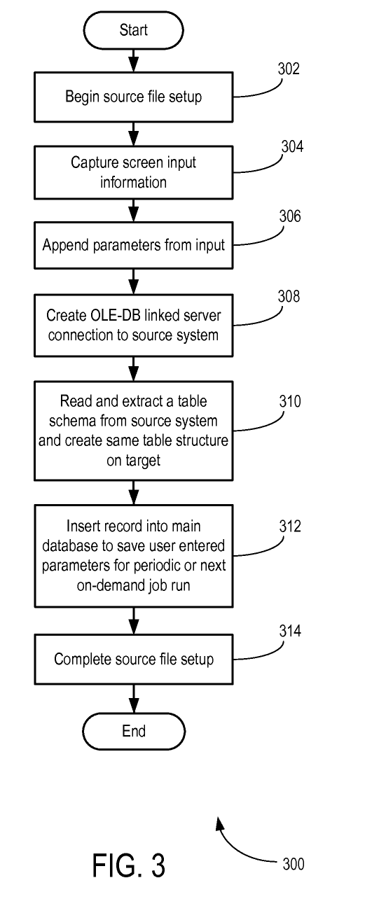

Now referring to FIG. 3, shown are schematic flowcharts of a method in accordance with an embodiment. As shown in FIG. 3, method 300 begins and at block 302 begins to set up the source file. Next, at block 304, method 300 catches screen input information entered by the user. Once the user completes entering input information to a graphical user interface screen, the software will capture and post this information.

Next, at block 306, method 300 invokes another stored procedure that will append the parameters from the input. Information entered from this page will pass to a number of stored-procedures as input parameters. The system and method will then dynamically create a data connection channel to the source system, and build a mirror image table of the source file based on this information.

At block 308, method 300 dynamically initiates an OLE-DB linked server connection to the source system. As mentioned in the preceding description, the system and method may use OLE-DB or other database connection drivers or web service APIs to establish a communication channel to the source system's files that are to be used to update the data warehouse. Once the connection is established successfully, method 300 will then read the source file/table structure and create the same table image on the target environment.

At block 310, method 300 reads and extracts a table schema from the source system and creates the same table structure in a target table. After the target table is created, method 300 dynamically closes the connection to the source system. During this process, all the fields in the source table are mapped one-to-one to the target table, including information such as field name and data type, etc. For example, the naming convention for the target table may be Staging_[SourceFileName], to method 300 to distinguish between the staging and warehouse tables.

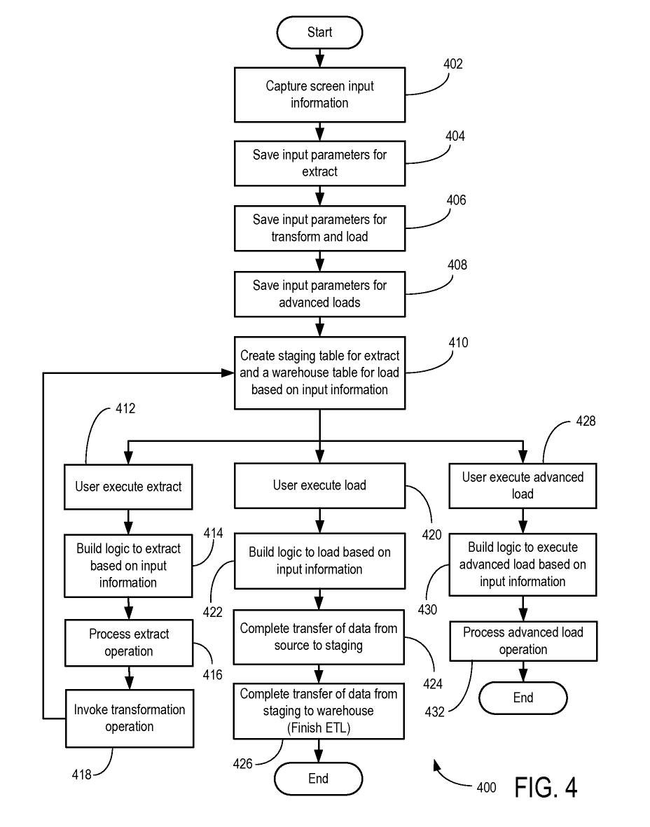

Now referring to FIG. 4, shown is a method 400 in accordance with an embodiment. As shown, method 400 begins and at block 402 captures screen input information entered at an input module. Method 400 then proceeds to block 404 where method 400 saves the input information for an Extract process. Next, method 400 proceeds to block 406 where method 400 saves input parameters for the Transform and Load processes. Next, method 400 proceeds to block 408 where method 400 saves input parameters for the Advanced Load processes.

As shown, method 400 requires a user to enter information in a predetermined sequence: Extract, Transform, Load and Advanced Load. At block 410, method 400 then creates a staging table for the Extract process, and a warehouse table for the Load process based on input information.

Still referring to FIG. 4, at block 412, method 400 performs a user Extract procedure. In order to Extract data from the source file to a corresponding target table, the user must enter information such as: select the transfer option (e.g. refresh, incremental, or interval), specify date and time stamp fields, and specify hash total fields. The user can also specify the history start date. The system and method also provides an environment that allows the user to select several options from the Extract process. In normal practice, each option may be preferable for a specific scenario. The following illustrative scenarios will describe these options in more detail:
1) If the source file size is small and contains reference data such as Country Code or Geographical Area Code, the user might select the “Refresh” option with no need to setup “History Start Date” or “Date Time Stamp” or “Hash Totals” since there are no currency fields in that file.
2) If a Transaction table, containing large volumes of data, is to be loaded into the warehouse, the user can select “Incremental” with “History Start Date”, “Date Stamp” and “Hash Totals” after the initial Load of historical data has been completed. The system and method will update this transaction (fact) table in the warehouse using a net change approach based on the last Extract Date and time. The system and method also provides a snap shot of the Hash Totals to compare back to the Source system. “History Start date” allows the user to pick a starting point for loading historical data into the Warehouse.
3) A third scenario is using an “Interval” option, which allows the user to select an interval between start Date Time and End Date time. The system will only bring in data that relates to that time interval.

At block 414, once the user executes the Extract procedure, method 400 will build logic to extract based on input information. Method 400 will save this information into a control table for future retrieval, create a new thread, and invoke an SSIS (i.e. an extract integration package) by passing all the parameter variables to that package. This extract integration package will then execute in each object control by invoking the appropriate procedure to handle a specific task. In this extract process, method 400 may dynamically invoke an OLE-DB connection to the source file, as previously described with respect to FIG. 3. Method 400 will read the source data file based on the extract information, then copy it to the associate target table. Method 400 may also record total row counts and summarizes the hash totals that user has specified from the screen.

At block 416, method 416 performs a process to extract data from the source system based on the parameter variables referenced in 414 above, and transfers that data to the staging environment.

At block 418, method 400 determines whether a Transformation is required for the imported data and invokes and executes the appropriate Transformation logic. From block 418, method 400 returns to block 410.

At block 420, method 400 performs a user Load procedure. Here, method 400 extracts data from the source table(s) into staging table(s) before setting up the screen for loading data from staging table(s) to the warehouse table(s). Information entered into this Load screen includes information such as: definition of table types, specification of the columns to be transferred to the warehouse, identification of the primary keys associated with these tables, and identification of filter(s) to be applied to the data being selected from the staging tables(s).

Once the user executes the Load procedure, at block 422, method 400 builds logic to Load based on input information, and saves this information into the control table for future retrieval, creating a warehouse table based on information entered by the user from the Load screen. When executing the Load procedure, method 400 will create a new thread and will invoke an SSIS (i.e. a load integration package) by passing all the parameter variables to that package. This package will then execute in each object control by invoking the appropriate procedure to handle a specific task. In this load process, the method 400 will copy data from staging table(s) into the warehouse table(s) based on the input information specified by the user. Also, in this process, the method 400 will record total row counts and summarize the hash totals that the user has specified through the input screen.

At block 424, method 400 completes the transfer of data from the source table to the staging table. Method 400 then proceeds to block 426, where method 400 completes the transfer of data from the staging table to the data warehouse. Method 400 then ends.

At block 428, method 400 performs an Advanced Load procedure. Here, method 400 then proceeds to block 430, where method 400 builds logic to execute an Advanced Load based on input information. This Advanced Load process is only required when there is a complex Load issue (such as integration with other source tables, providing high level summary table(s), etc.) that is not handled by the basic functionality.

At block 430, method 400 builds logic to execute the Advanced Load based on input information. A user will typically perform the standard Load before attempting to use this process. When using the Advanced Load page, a technical person can add more custom code to handle more complex, unanticipated processing scenarios. This Advanced Load procedure allows users to execute SQL scripts, stored procedures and/or SSIS packages. In an embodiment, any custom program that may be integrated may be managed and maintained by method 400. The system and method allows the user to add any type of custom code desired. Users can develop their own custom code and Save their code setting in Advanced Load. The system and method will then manage these custom programs and execute them on-demand, or as part of a regularly scheduled batch updating process. If the user chooses not to save their custom program in Advanced Load, they must invoke their program during their own on-demand or scheduled update runs. They then have to manage their own exception handling.

Method 400 then proceeds to block 432 to process an Advanced Load operation. Method 400 then proceeds to end.

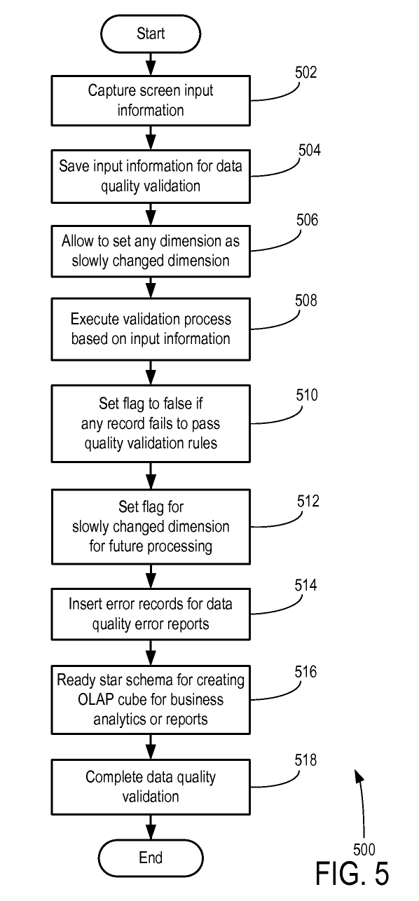

Now referring to FIG. 5, shown is a method 500 in accordance with an embodiment. Method 500 begins, and at block 502, captures the screen input information. Here, the user may enter input information at web pages such as regular (dimension) table and transaction (fact) table screens.

At block 504, method 500 captures and saves the input information into a control table for future retrieval. Method 500 also handles data quality validation by checking various columns specified in the data quality setup screens. There are two types of Data Quality Validation Dimension Tables Validation and Fact Tables Validation. The system and method provides a web page for the user to specify Data Validation needs. When these needs are specified on the screen, they are saved to various tables in the system database.

At block 506, method 500 flags any records that do not pass the validation rules test(s) and will also flag column(s) (dimension(s)) as slowly changing dimensions for future validation checking. For example, a salesperson named John may be transferred from one state to another. The Sales Region of that salesperson will change, but this type of change is not a common occurrence, and will only happen occasionally, if at all. The system and method will track all those changes as Slowly Change Dimension.

At block 508, method 500 executes the validation process based on input information, and records all the failed records into an error table and provides a report to end user for correcting the source data causing these errors.

At block 510, method 500 sets a data quality flag to false if any records fail to pass that the quality validation rules. Method 500 then proceeds to block 512, where method 500 sets a flag for slowly change dimensions for future processing. Then at block 514, method 500 inserts error records for data quality error reports.

Method 500 then proceeds to block 516, where method 500 readies a star schema, a data warehouse schema style for creating an online analytical processing (“OLAP”) cube for business analytics or reports.

Method 500 then proceeds to block 518 to complete data quality validation, then method 500 ends.

While illustrative embodiments have been described above, it will be appreciated that various changes and modifications may be made. More generally, the scope of the invention is defined by the following claims.

What is claimed is:

1. A method executable on a data processing device for building a data warehouse, comprising:
receiving extract input parameters for extracting data from a source data file;
in dependence upon the received extract input parameters, building a communications channel to a selected one of a plurality of source database management systems containing the source data file;
extracting data from the selected source data file and storing the extracted data into a staging table;
receiving transform and load input parameters for transforming data stored in the staging table and loading the transformed data into a data warehouse table; and
in dependence upon the selected source database management system and the received extract, transform and load input parameters, selecting pre-built modules for building the data warehouse with the data warehouse tables loaded with the transformed data.

2. The method of claim 1, further comprising:
receiving advanced load input parameters; and
in dependence upon the selected source database management system and the received advanced load input parameters, selecting pre-built modules for performing the advanced loading of transformed data into a data warehouse table.

3. The method of claim 1, wherein building the communications channel comprises dynamically creating an object linking and embedding (OLE) database server connection to the source database management system.

4. The method of claim 1, further comprising:
in dependence upon data validation input parameters and upon completion of loading all tables, executing a data quality validation process on data stored in the tables;
identifying any data records failing the data quality validation process; and
verifying data integrity of the identified data records as they await correction of the source system files.

5. The method of claim 4, further comprising executing the data quality validation process based on comparing the data to organization business rules.

6. The method of claim 1, wherein the pre-build modules are specific to each one of the plurality of source database management systems, and selection of the appropriate pre-build modules is made automatically based on user selection of the source database management system.

7. The method of claim 1, further comprising modifying user interfaces for receiving transform and load input parameters in dependence upon the received extract input parameters and the selected source database management system.

8. A system for building a data warehouse, the system including processing means and memory means adapted to:
receive extract input parameters for extracting data from a source data file;
build a communications channel to a selected one of a plurality of source database management systems containing the source data file in dependence upon the received extract input parameters;
extract data from the selected source data file and storing the extracted data into a staging table;
receive transform and load input parameters for transforming data stored in the staging table and loading the transformed data into a data warehouse table; and
select pre-built modules for building the data warehouse with the data warehouse tables loaded with the transformed data in dependence upon the selected source database management system and the received extract, transform and load input parameters.

9. The system of claim 8, wherein the system is further adapted to:
receive advanced load input parameters; and
select pre-built modules for performing the advanced loading of transformed data into a data warehouse table in dependence upon the selected source database management system and the received advanced load input parameters.

10. The system of claim 8, wherein the system is further adapted to build the communications channel comprises dynamically creating an object linking and embedding (OLE) database server connection to the source database management system.

11. The system of claim 8, wherein the system is further adapted to:
execute a data quality validation process on data stored in the tables in dependence upon data validation input parameters and upon completion of loading all tables;
identify any data records failing the data quality validation process; and
verify data integrity of the identified data records as they await correction of the source system files.

12. The system of claim 11, wherein the system is further adapted to execute the data quality validation process based on comparing the data to organization business rules.

13. The system of claim 8, wherein the pre-build modules are specific to each one of the plurality of source database management systems, and selection of the appropriate pre-build modules is made automatically based on user selection of the source database management system.

14. The system of claim 8, wherein the system is further adapted to modify user interfaces for receiving transform and load input parameters in dependence upon the received extract input parameters and the selected source database management system.

15. A data processor readable medium for storing data processor code that when loaded into a data processing device adapts the device to perform a method of building a data warehouse, the data processor readable medium comprising:
code for receiving extract input parameters for extracting data from a source data file;
code for building a communications channel to a selected one of a plurality of source database management systems containing the source data file in dependence upon the received extract input parameters;
code for extracting data from the selected source data file and storing the extracted data into a staging table;
code for receiving transform and load input parameters for transforming data stored in the staging table and loading the transformed data into a data warehouse table; and
code for selecting pre-built modules for building the data warehouse with the data warehouse tables loaded with the transformed data in dependence upon the selected source database management system and the received extract, transform and load input parameters.

16. The data processor readable medium of claim 15, further comprising:
code for receiving advanced load input parameters; and
code for selecting pre-built modules for performing the advanced loading of transformed data into a data warehouse table in dependence upon the selected source database management system and the received advanced load input parameters.

17. The data processor readable medium of claim 15, wherein the data processor readable medium further comprises code for building the communications channel by dynamically creating an object linking and embedding (OLE) database server connection to the source database management system.

18. The data processor readable medium of claim 15, wherein the data processor readable medium further comprises:
code for executing a data quality validation process on data stored in the tables in dependence upon data validation input parameters and upon completion of loading all tables;
code for identifying any data records failing the data quality validation process; and
code for verifying data integrity of the identified data records as they await correction of the source system files.

19. The data processor readable medium of claim 15, wherein the data processor readable medium further comprises code for executing the data quality validation process based on comparing the data to organization business rules.

20. The data processor readable medium of claim 15, wherein the pre-build modules are specific to each one of the plurality of source database management systems, and the data processor readable medium further comprises code for selecting the appropriate pre-build modules automatically based on user selection of the source database management system.

21. The data processor readable medium of claim 15, wherein the data processor readable medium further comprises code for modifying user interfaces for receiving transform and load input parameters in dependence upon the received extract input parameters and the selected source database management system.
